(19) United States
(12) Patent Application Publication
(10) Pub. No.: US 2010/0079992 A1
(43) Pub. Date: Apr. 1, 2010

(54) LIGHTING DEVICE AND LIGHT THERAPY DEVICE ASSOCIATED THEREWITH

(75) Inventors: Esther De Beer, Eindhoven (NL); Lucas Josef Maria Schlangen, Eindhoven (NL); Gregorius Wilhelmus Maria Kok, Eindhoven (NL); Adnreas Martinus Theodorus Pauli Van Der Putten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/518,294

(22) PCT Filed: Dec. 12, 2007
(86) PCT No.: PCT/IB07/55050

§ 371 Date: Jun. 9, 2009

(30) Foreign Application Priority Data
Dec. 15, 2006 (EP) 06126212.7

(51) Int. Cl. F21V 1/00; F21S 8/00

(52) U.S. Cl. 362/235; 362/277

(57) ABSTRACT

The invention provides a lighting device (1) comprising a housing (10) which comprises a light source (13), an emission window (2) for the light, and a semitransparent layer (4; 7, 8; 19, 20, 21); a controllable absorber (18; 22, 23; 25; 30) extending over a substantial portion of the complete optical window (2); and a control unit (15) for controlling the light source (13) and the absorber (18; 22, 23; 25; 30), wherein the absorber is controllable between a first state with an average transmittance of the lighting device (1) with respect to the produced light of at least 50% and a second state with an average transmittance of the lighting device (1) with respect to the produced light of at most 10%.

### FIELD OF THE INVENTION

The present invention generally relates to a “hidden” lighting device, i.e. a lighting device that does not look like a lighting device.

In particular, the present invention relates to a lighting device comprising a housing which comprises a light source for producing light, an emission window positioned to allow emission of the light, and a semitransparent layer.

### BACKGROUND OF THE INVENTION

Although lighting devices are an integral part of everyday life, and also an important part of e.g. people's homes, it is sometimes desirable to hide at least its function, because the functional parts of a lamp are not always pleasant to look at in a living-room or the like. For example, document US 2005/0195972 discloses a decorative interface display that is concealed behind a semitransparent mirror.

A disadvantage of the known device is that its efficiency is not always satisfactory. In particular, the known devices often suffer from a hazy mirror image, or light from the internal light source is blocked to a too high degree.

### OBJECT OF THE INVENTION

It is an object of the invention to provide a lighting device that is able to provide a good efficiency, while still able to hide the function of the light source in the device.

### SUMMARY OF THE INVENTION

The present invention achieves its object by means of a lighting device according to claim 1, comprising a housing which comprises a light source for producing light, an emission window positioned to allow emission of the light, a semitransparent layer, a controllable absorber that extends over a substantial portion of the complete emission window, and a control unit for controlling the light source and the absorber, wherein the absorber is controllable between a first state with an average transmittance of the lighting device with respect to the produced light of at least 50% and a second state with an average transmittance of the lighting device with respect to the produced light of at most 10%.

As a general remark, the transmittance of the lighting device should be counted as the transmittance of the absorber and the emission window with the semitransparent layer. It does not include any other layers, if provided, such as diffusers or the like that may be present. Furthermore, “over a substantial portion of the complete emission window” means “over a continuous surface area of at least 5% of the complete emission window”. This will be elucidated hereinafter. Furthermore, the above figures hold for both the semitransparent layer and the absorber, although it should be noted that the actual extent of the semitransparent layer over the emission window may be different from that of the absorber.

The invention is based on the recognition that a controllable absorber with varying absorption states may advantageously be used. A high absorption is favorable when the lamp is off, because then any light that passes the semitransparent layer will not be reflected by an internal reflective surface such as a diffuser or fluorescent tube. This would blur the (mirror or other) image, or would affect the concealment of the light source, etc. However, a high absorption would take away much of the light of the internal light source when this is on.

Contrarily, a low absorption state, which could cause much blur as discussed above, may be used when the light source is on, because then the image or mirror image at the front of the device becomes irrelevant anyway, and as much light as possible should be transmitted.

Now, by providing an absorber that is able to switch between these states, an efficient lighting device is provided that is better able to conceal its function, e.g. by serving as a mirror, a painting, etc. This will all be elucidated hereinafter.

Note that there is known in the art a Mirror TV of the Philips company, which is an LCD television set which, in the off state, has a mirror function. To achieve this, the LCD is covered with a semitransparent semispecular film, similar to the one in the document cited above. Although the liquid crystal panel of this TV set could be considered a controllable absorber, this anticipation is deemed coincidental, because the transmission of such a panel is (far) less than 20%, and often hardly 8%, due to the use of polarizers, color filters, a limited aperture between pixel electrodes and data connections, etc. Such a low transmission will not be considered for lighting purposes, and is way outside the desired range of transmission according to the invention.

Advantageous and special embodiments will be described in the dependent claims, as well as below.

In particular, the average transmittance in the first state is at least 60%, preferably at least 80%.

Obviously, a higher average transmittance in the first state is preferable because it increases the efficiency of the lighting device. By separating the first and second states according to the invention, it is achieved that such a high transmittance in the first state does not decrease the functionality in the second state. This will be elaborated by means of various examples below.

In particular, the average transmittance in the second state is at most 5%, preferably at most 1%. For similar reasons as stated above, it is relatively easy to provide a second state with a very high average absorption, i.e. a very low transmittance. Ideally, the average transmittance is substantially 0 in the second state, and similarly substantially 100% in the first state.

In a special embodiment, the absorber has a substantially homogeneous transmittance over at least 10% of the emission window, for example over substantially 100% of the emission window. Especially in cases in which the absorber has a certain distance to the front surface of the emission window, any inhomogeneity of the absorber will become less visible. In general, the more homogeneous the transmittance over the emission window, the more effective and the more pleasing to the eye the lighting device. In an embodiment that is advantageous under certain circumstances, the transmittance is substantially the same over substantially 100% of the emission window. However, building up the absorber from a plurality of partial absorbers is also a possibility, as will be elucidated hereinafter.

In an embodiment, the absorber comprises a mechanically moveable shutting device. In this embodiment, the mechanically movable shutting device, which will be opaque by itself, can be positioned between the light source and the emission window in the second state and is removed therefrom in the first state. With such a movable shutting device, it is very easy to achieve a very low transmittance of substantially 0% in the second state and a very high transmittance of 80% in the first state. The shutting device may comprise e.g. lamellae, blinds, Venetian blinds, a screen, etc. The movability may be motor supported.

In particular, the shutting device comprises rotatable blinds or a movable screen, in much the same way as sun blinds in a house. These are very simple and effective devices, with a reliable technology.

In a special embodiment, the absorber comprises an electrochromic substance. As is known per se in the art, an electrochromic substance changes, or more in particular changes its absorption, when a sufficient voltage is applied across it. By providing the electrochromic substance, and obviously the required electrodes, it is very simple to vary between the first and the second state. If so desired, a number of the electrochromic substances may be stacked, especially different substances, in order to achieve a sufficiently low transmittance in the second state. Electrochromic materials are deemed to include materials capable of switching between a reflective state and a transparent state, either through application of a voltage or injection of hydrogen and oxygen. An example of the latter material is a nickel-magnesium alloy, which is also used, for example, in auto-dimming rear view mirrors.

In an embodiment, the absorber comprises an electrowetting cell. Such an electrowetting cell comprises an electrowetting fluid and electrodes for providing a desired electric field across the electrowetting fluid. For example, if the electrowetting fluid is absorptive by itself or comprises absorptive particles such as carbon black, the change in shape caused by the electrowetting process can change the effective absorption surface area. For example, the electrowetting fluid is provided as a substantially homogeneous layer in the second state. In the first state, a suitable electric field is applied and the electrowetting fluid shapes into a number of droplets, thus having a smaller surface area with respect to the emission window. Hence, the transmission is increased. In particular, the droplets will concentrate around either positive or negative electrodes. If such electrodes are provided with a reflective (e.g. white or specular) layer that faces the light sources, substantially all radiation that would have been absorbed by the absorptive electrowetting fluid will now pass through the emission windows unhindered. This is a special case of a high- and low-transmission absorber.

In a particular embodiment, the absorber comprises a liquid crystal device having at least one cell, and preferably having one cell, with an area of at least 100 cm², preferably at least 400 cm². As was discussed above in relation to the Mirror TV, liquid crystal devices themselves are also controllable absorbers. However, the liquid crystal devices in LCD TV sets have a too low transmission in the first state. However, since in the present invention different colors, pixels, etc. are not required in the controllable absorber, the effective surface area of the liquid crystals, or at least thereof, can be made much larger, preferably as indicated in the claims. In fact it is readily possible to provide a single liquid crystal cell for the entire emission window. This means that the two sides of the emission window are each provided with a single electrode with liquid crystal in between. Note that in general such a liquid crystal device also uses two polarizers. In one state, the polarizers cooperate to block light through the liquid crystal device, while in the other state a rotation of a plane of polarization is such that a transmission is higher, or vice versa.

In particular, the semitransparent layer comprises a semitransparent mirror with a reflectance of between 5% and 25%, preferably between 10 and 20%. In principle, it could be sufficient if the semitransparent layer has a low reflectance of e.g. 5%, especially in cases where the controllable absorber has a high absorption. In that case even a faint reflection will not be overshadowed by a large amount of internally reflected light. Preferably, however, the reflectivity is higher, such as between 10 and 20%, which was found to give satisfactory results. Note that light that passes through the absorber in the second state, that is internally reflected at e.g. a diffuser, and that passes through the absorber again, is attenuated by at least a factor of 4.

In another embodiment, the semitransparent layer comprises a fixed image layer. Instead of a mirror, it is also possible to provide a fixed image on a fixed image layer. In this way it is possible, for example, to mimic a painting or the like.

In a special embodiment, the fixed image layer comprises at least one semitransparent area, in particular a continuous area extending substantially across the emission window, preferably at least partly colored. Herein, the word semitransparent is intended to indicate ‘having a transmittance of at least 40%, preferably 60%’. Note that the average transmittance of the emission window should be in the indicated range according to the invention. The transmission of the semitransparent area may be lower in certain smaller areas. In the embodiment presently described, the fixed image layer may comprise e.g. a colored film, a watercolor layer, etc. Such layers transmit sufficient light while still giving the perception of an image if the light source is not lit.

In a special embodiment, the fixed image layer comprises at least one substantially non-transparent area, in particular a pixilated area. For better visibility of the fixed image, a substantially non-transparent area, such as a paint dot or the like, in particular a pixilated area, is advantageous, still keeping in mind that the average transmittance of the lighting device remain within the limits of the invention.

In particular, at least one substantially non-transparent area comprises a reflective layer facing the light source and a differently colored area facing away from the light source. Such a reflective layer serves to improve the total efficiency of the lighting device in that it reflects light that would have been absorbed by the colored area facing away from the light source. Again, the reflective layer may comprise a highly diffusely reflecting material such as titanium dioxide, or a specularly reflective (=mirroring) material. Furthermore, the differently colored area may comprise an area with one or more colors, including white, gray, and black.

The semitransparent layer may be part of the emission window, e.g. applied on a front or back surface thereof, or within the emission window. It may also be a separate layer positioned in front of the emission window proper or behind it, in front of the absorber. Since it will be a very thin layer in many cases, it will be advantageous from a mechanical point of view to provide it on the emission window proper, but this is not necessary.

The light source of the lighting device according to the present invention may comprise any desired light source, such as incandescent lamps, halogen lamps, LEDs, fluorescent tubes, etc. Similarly, the spectrum of the light source may comprise any desired spectrum. Advantageous spectra comprise daylight spectra, UVA spectra, and so on. Such spectra may be selected in accordance with, for example, a treatment for a user. For example, intense daylight to treat Seasonal Affective Disorder (SAD), blue light e.g. to treat hyperbilirubinemia, and so on.

In particular, the light source comprises at least one fluorescent lamp. Fluorescent lamps have a very high luminous efficacy, may have almost any desired spectrum in the visible and UV range, and are easily exchangeable, for example for adapting the spectrum emitted by the device. Other advantages will be evident to those skilled in the art.

In an embodiment, the light source of the device according to the invention comprises a display device, such as a monitor or TV, in particular a Mirror TV, such as the one mentioned above. In this embodiment, the TV is hidden efficiently, while the achievable high transmittance of the controllable absorber allows unimpeded watching. Note that the TV may be a CRT, an LCD, or any other type.

In an embodiment, the power density of the light source is between 100 and 1000 W/m². The electrical power density obviously depends on the luminous efficacy of the light source. However, other power densities are useful as well, such as lower power densities which provide a more pleasant lighting in living-rooms and the like.

In a particular embodiment, the light source comprises a plurality of LEDs. LEDs have advantages such as a high luminous efficacy, a long life, and compactness. This means that a very high intensity can be obtained with a relatively low electrical power density. Of course, other light sources are also possible, such as medium or (super) high-pressure mercury vapor discharge lamps, which are able to provide exceptionally high intensities.

In an embodiment of the device according to the invention, the illuminance at a distance of 0.5 m perpendicular to the device area is at least 1,000 lx, preferably between about 2,000 and 20,000 lx. Such illuminance levels are advantageous for many uses, such as various light therapies. Those skilled in the art can easily select suitable light sources to obtain such an illuminance without having to rely on exotic high-power lamps. The invention provides the possibility to use ordinary lamps for such purpose. Again, for other purposes, other illuminance values are possible as well, such as 400-500 lx at the desk surface for general lighting.

In an advantageous embodiment, the device further comprises a housing-moving mechanism, preferably a tilting mechanism. The housing of the device, and in particular the emission window thereof, may be positioned by means of such a housing moving mechanism for use by a user. It is especially advantageous to provide such a mechanism in the case of a light therapy device in order to be able to provide an effective therapy, e.g. by making the distance between the emission window and the user small. When the device is not being used, the housing-moving mechanism may be, for example, folded or the like, such that the device assumes a normal position for a painting, a mirror, etc. A wall-mounted device is advantageous in such a case. However, any other method of providing or mounting the device is also contemplated.

In a special embodiment, the absorber comprises at least two parts, each of which extends across a substantial portion of the complete optical window, at least one of said two parts being controllable by the control unit independently of another of said at least two parts. This allows a lighting device to have two or more, but preferably at most about 20 different part windows, which may be used for various purposes. For example, one part, such as preferably a central part, may be given a special feature, such as a TV or other display feature. Alternatively, various parts may each be given a different display function, such as for different devices or conditions to be monitored, or a clock, a videophone, and so on.

The invention also provides a light therapy device, comprising a lighting device according to the invention, the control unit thereof being arranged to control the intensity and/or duration of the light emitted by the device. Such a light therapy device is advantageous in that its purpose of a therapy device is well concealed, but still easily used. For example, a person suffering from psoriasis or SAD may mount the light therapy device in his/her house, such as to a wall. When not in use the light therapy device is simply seen as a decorative element, such as a mirror or painting. In use, the user is positioned in front of the light therapy device and is subjected to irradiation. Advantageously, the light therapy device is positioned by means of a housing-moving mechanism.

### BRIEF DESCRIPTION OF THE DRAWINGS

FIG. 1 diagrammatically shows a lighting device 1 according to the invention in front elevation;

FIG. 2 diagrammatically shows an enlarged view of the detail 5 of the device 1 of the FIG. 1;

FIGS. 3A and 3B diagrammatically show two positions of the device 1 with respect to a wall 9;

FIG. 4 diagrammatically shows a cross-sectional view of a device according to the invention;

FIGS. 5A en 5B show a detail in cross-section of an emission window 2 with a permanent image;

FIG. 6 shows another embodiment of the device of the invention in a cross-sectional view; and

FIG. 7 shows other possible embodiments of the absorber for use in the device of the invention in a diagrammatic cross-sectional view.

### DETAILED DESCRIPTION OF EXAMPLES

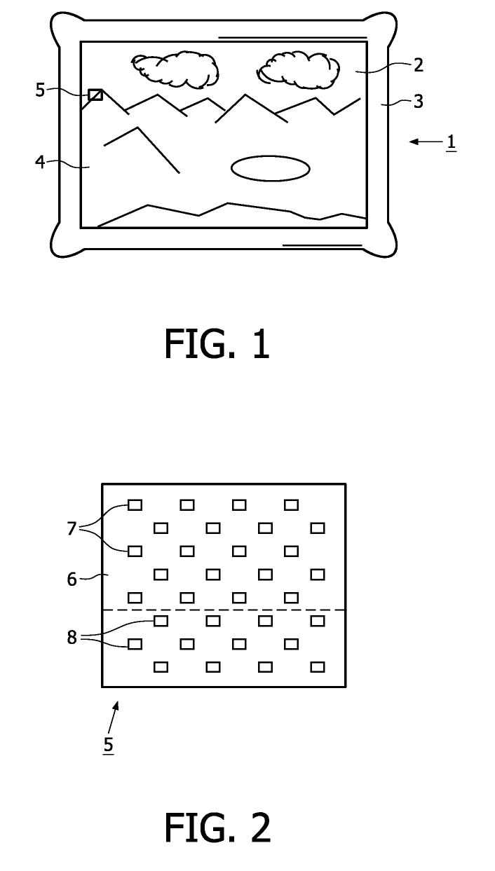

FIG. 1 is a diagrammatic front elevation of a lighting device 1 according to the invention.

The device 1 comprises an emission window 2 situated within a frame 3 and comprising a fixed image 4. A detail of the fixed image 4 is referenced 5.

The lighting device according to the invention shown here has the appearance of an ordinary painting. The fixed image 4 may be any desired image. However, for reasons to be discussed below, mostly light-colored images are preferable. Hence, winter landscapes, mountainous landscapes with lots of snow, or abstract images with lots of white or pale colors prevent a too high absorption. Obviously, the frame 3 is purely optional, but may be used to blend the device 1 into an interior design.

In the embodiments shown in the Figures, the emission window is a flat panel. It is however equally well possible to provide a curved emission window, with the same advantages according to the invention.

FIG. 2 diagrammatically shows an enlarged view of the detail 5 of the device 1 of the FIG. 1. Herein, 6 denotes a transparent sheet, while 7 denotes white dots and 8 denotes blue dots. The dashed line between the white dots 7 and the blue dots 8 is a virtual line, indicating a boundary line which is also visible in FIG. 1.

As can be seen in FIG. 2, the basic emission window 2 comprises a transparent sheet 6, such as a glass or plastic sheet. The transmission thereof may of course be very high, especially with non-glare coatings. In such cases, the transmission may be, for example, 99%. A number of dots or pixels 7, 8 are applied on the transparent sheet 6, e.g. by painting, printing, etc. The density of the dots 7, 8 should be selected such that the fixed image 4 is well perceivable, and the transmission of the emission window 2 is still sufficiently high. Furthermore, the density is also dependent on the transmission of the individual dots. For example, if the dots 7 comprise an opaque material, their density is preferably lower than in the case of a semitransparent material for the dots. In practice, a density of 15-20% of the area is a functional example. Note that this density relates to the total density of dots on the emission window 2. It is only the total emission that counts, except for special circumstances.

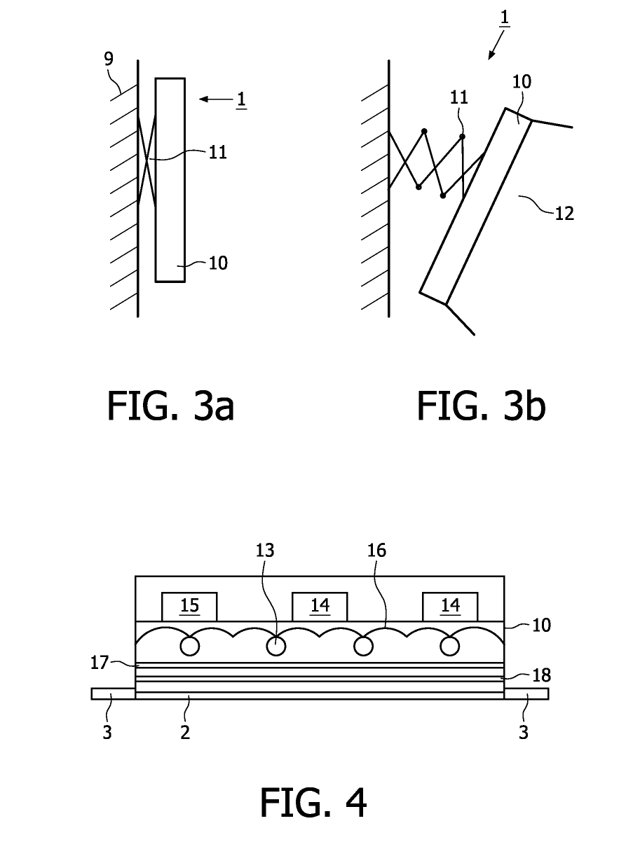

FIGS. 3A and 3B diagrammatically show two positions of the device 1 with respect to a wall 9.

FIG. 3A shows the device 1 in a position in which the device is not in use and simply serves as a painting, a mirror or the like. The housing 10 of the device is kept close to the wall 9 by means of a linkage assembly 11, which is folded-in here.

In FIG. 3B, the linkage assembly 11 is folded out and the device, or in particular the housing 10 thereof, is now positioned in a suitable position for use by a user. The light source is switched on, and the device emits a beam of light 12. Note that a beam represents simply all of the emitted light, not having any particular dimension.

Furthermore, the linkage assembly 11 may be replaced by any other means for positioning the housing 10 of the device 1.

In the embodiments disclosed in the Figures thus far, the emission window 2 comprises a fixed image 4. Note, however, that it is also possible to provide the emission window with a semitransparent layer, such that a mirror effect is obtained. To this end, a partly mirroring surface, or e.g. a surface with a very thin layer, may be provided, such that the reflectance is, for example, 10-20%.

FIG. 4 is a diagrammatic cross-sectional view of a device according to the invention.

Herein, the housing 10 is closed by means of an emission window 2 surrounded by a frame 3.

Light sources 13 with power supplies 14 and a control unit 15, with a reflector 16 between them, are provided in the housing 10. 17 denotes a diffuser, while 18 is an absorber.

The light sources 13 are fluorescent tubes, in this case four tubes positioned in parallel. Other sources may obviously be used, such as LEDs. The light sources 13 are operationally connected to power sources 14, such as ballasts and/or ignition devices. The power supplies may be operationally connected to a control unit 15.

The reflector 16, which is optional, is positioned behind the light sources 13 in order to increase the amount of light emitted through the emission window 2. The reflector may be an optional accessory or may be incorporated into the light source 13 itself, for example in the form of a reflector tube.

The diffuser 17 increases the homogeneity of the emitted light, which is desirable for lighting purposes. However, the diffuser is optional, being omitted, for example, if the density of light sources is already such that a sufficient homogeneity is obtained. Such a diffuser may comprise, for example, frosted glass or the like.

The semitransparent layer is not shown separately. It may be positioned on, in, or in front of the emission window 2, or may be positioned between the absorber 18 and the emission window 2.

The absorber 18 is controllable so as to assume at least two states, for example by means of the control unit 15. The absorber 18 has at least a low-transmission state and a high-transmission state. In this case the absorber 18 is, for example, an electrochromic device. Such a device consists of an electrochromic material which can be electrically switched between two absorption states. A higher-transmission state and a lower-transmission state can be provided through a proper selection of the material. Examples of electrochromic materials are tungsten oxide and the materials used in so called Smart Windows.

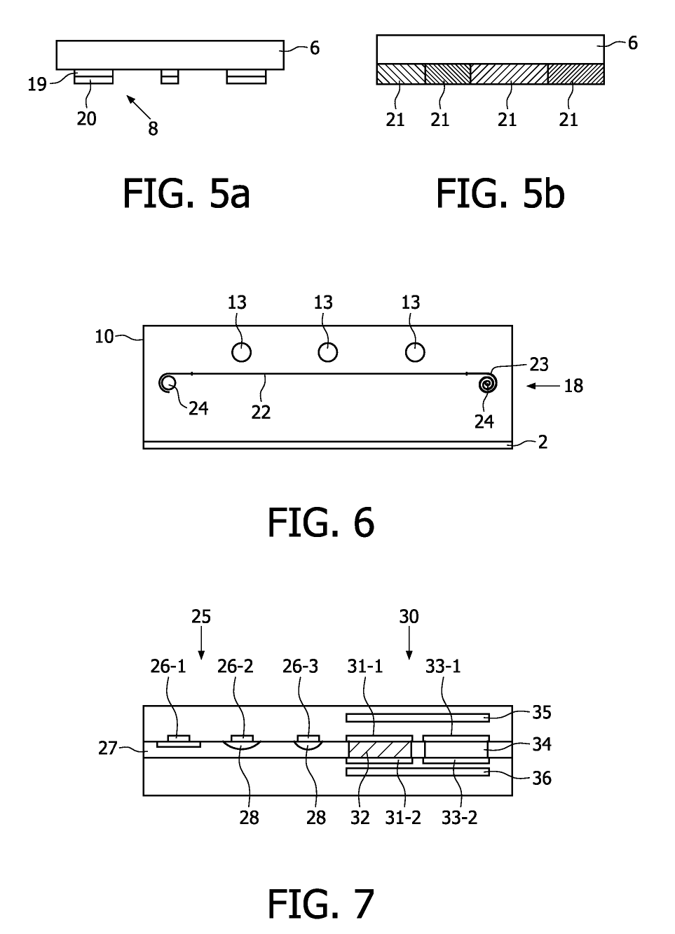

FIGS. 5a en 5b show a detail in cross-section of an emission window 2 with a permanent image.

Herein, a number of pixels or dots 8 is applied onto a transparent sheet 6 comprising a reflective layer 19 and a colored layer 20 as in the case of FIG. 5A, or a semitransparent colored layer 21 as shown in FIG. 5b.

The optional reflective layer 19 in FIG. 5a, e.g. made of titanium dioxide or some other highly reflective white material or metal or dichroic mirror layer, serves to reflect light that would have been absorbed by the colored layer 20. Since this light is now reflected, it can be reflected back by e.g. a diffuser or the like. The efficiency is increased thereby.

In FIG. 5B, the semitransparent colored layer is continuous. Various areas of color may be embedded in this continuous layer, for example in much the same way as in an aquarelle. The optical density of the materials used should be such here that a sufficient transmission is obtained. Again, this holds for the average transmission of the complete emission window and need not be preserved for every specific color or area thereof.

FIG. 6 shows another embodiment of the device of the invention in a cross-sectional view.

Herein, as in all of the drawings, similar parts are denoted by the same reference numerals.

Three light sources 13 and a controllable absorber 18 are present in a housing 10. The absorber 18 comprises a transparent screen part 22 and an opaque screen part 23, which are wound on two reels 24. Not shown is a motor for rotating the reels so as to unwind or wind the screen parts 22, 23. In as first position, the transparent screen part 22 is moved into a position between light sources 13 and emission window 2. The transparent screen part 22 comprises, for example, a transparent plastic film. In another situation, the motor winds the transparent screen part 22 onto the left-hand reel 24, whereby the opaque screen part 23 is unwound from the right-hand real 24. The opaque screen part 23 comprises, for example, a similar transparent film, but now covered with an opaque layer, such as a paint or metal. Such an additional layer may be applied by any known technique, such as vapor deposition, spraying, etc. It is also possible to use a different material which is inherently opaque.

As an alternative, or in addition, other mechanically movable means may be used as a controllable absorber, such as lamellae, (Venetian) blinds, and so on.

FIG. 7 shows other possible embodiments of the absorber for use in the device of the invention in a diagrammatic cross-sectional view.

FIG. 7 shows two different embodiments, with an electrowettable device on the left and a liquid crystal device on the right.

A first absorber cell 25 is shown in the electrowettable device on the left, with three electrodes 26-1, 26-2, and 26-3. 27 denotes a cavity and 28 denotes droplets of an electrowetting fluid. Not shown a is counter-electrode associated with the electrodes 26.

In the first absorber cell 25, there is a first voltage between the counter-electrode and electrode 26-1, causing the leftmost droplet 28 to have a first wettability at the surface near the electrode. The voltage between the counter-electrode and electrodes 26-2 and 26-3 has a different value, causing the other two droplets 28 to have a different wettability with respect to the surface near the electrode, in particular such that the wetting power is decreased and a droplet is formed instead of a relatively thin film. Herein, the fluid of the droplets 28 moves within an empty cavity 27. It is also possible to provide two fluids such that the shape of the first fluid changes under the influence of the voltage across it. Details of such electrowetting cells are deemed known to those skilled in the art.

The first absorber cell functions such that, in the first transmitting state, the droplets 28 are present in their contracted form. The fluid, being the absorbent in this case, is caused to retract around the electrodes 26. In other words, the absorbing surface area is decreased from substantially the entire surface, i.e. the case in which the thin films as shown at electrode 26-1 contact each other, into relatively small-area droplets, as shown around electrodes 26-2 and 26-3. The overall absorption is decreased in this case. The net transmittance may even be increased more in that the electrodes are provided with a reflecting material at their sides that face the light sources. In fact, many metal electrodes will have a sufficiently high reflectivity. In such a case, the absorption can be made very low.

Two liquid crystal cells 30 are shown on the right. Reference numerals 31-1 and 31-2 denote two electrodes around a first liquid crystal 32, while 33-1 and 33-2 are second electrodes around second liquid crystal 34. 35 and 36 are a first and second polarizer.

These second absorber cells 30, or liquid crystal cells, function according to a well-known principle in the first, transparent state, as represented by the non-hatched second liquid crystal 34, wherein the voltage between electrodes 33-1 and 33-2 is such that the plane of polarization of light entering the second liquid crystal 34 via the first polarizer 35 matches the plane of polarization of light emitted and passing through second polarizer 36. In the case of crossed polarizers 35 and 36, the second liquid crystal 34 should be made to rotate said plane of polarization sufficiently. If the polarizers 35 and 36 are parallel, the second liquid crystal cell 34 should obviously not rotate the plane of polarization.

In the absorptive state represented by the hatched first liquid crystal 32, however, the voltage between the electrodes 31-1 and 31-2 is reversed with respect to the voltage between the electrodes 33-1 and 33-2. Note that it is the respective cell as a whole that is transparent or absorptive, not the individual liquid crystal.

It is noted that the use of polarizers decreases the maximum transmission if use were made of non-polarized light. However, if essentially linearly polarized light is used, such as in the case of superluminescent diodes, which can emit elliptically polarized light with an axial ratio of about 20:1, the effective transmission coefficient of liquid crystal cells is very high in the transmitting state and very low in the absorptive state. When working with anti-glare coatings, values of 80% and 2%, respectively, or better are easily obtainable.

The embodiment shown in FIG. 7 is an example of a device according to the invention with two or more absorber parts that are independently controllable by a control unit. This offers the possibility to light only a part of the device, simply by maintaining one or more of the absorbers in a low-transmission state. A nice example could be a make-up mirror or artist's mirror. A conventional make-up mirror comprises a mirror with a number of light bulbs along the edge. A mirror according to the invention could comprise an absorber with a central part that is not switched, or even cannot be switched, from a low-transmission state. This part will accordingly retain its original state, which is preferably a mirroring state. The surrounding part, however, may be switched to a high-transmission state, allowing light of the light sources to shine through. This offers aesthetic design possibilities and makes for a mirror that can be easily cleaned. Moreover, since the absorber is controllable, the mirror size may be varied, and any number of people may obtain their own mirror.

Other possibilities could be to provide a TV, a clock, or the like as a light source in the device according to the invention, for example in a part of the device. Again, the absorber part around the, e.g. central, part of the TV (or clock etc.) could be controlled differently. The central part could now be switched from a low-transmission (i.e. mirroring) state to a high-0transmission state. The TV now is a central part in a large surrounding mirror. In addition, the surrounding low-transmission part could then further be switched to a high-transmission state, which renders it possible, for example, for features like AmbiLight by Philips to be appreciated.

1. A lighting device (1) comprising a housing (10), the device comprising:
a light source for producing light;
an emission window positioned to allow emission of the light;
a semitransparent layer and a controllable absorber extending across a substantial portion of the complete emission window; and
a control unit for controlling the light source and the absorber, wherein the absorber is controllable between a first state with an average transmittance of the lighting device with respect to the produced light of at least 50% and a second state with an average transmittance of the lighting device with respect to the produced light of at most 10%.

2. The device according to claim 1, wherein the average transmittance in the first state is at least 60%, preferably at least 80%.

3. The device according to claim 1, wherein the average transmittance in the second state is at most 5%, preferably at most 1%.

4. The device according to claim 1, wherein the absorber has a substantially homogeneous transmittance over at least 10% of the emission window (2).

5. The device according to claim 1, wherein the absorber comprises a mechanically moveable shutting device (22, 23).

6. The device according to claim 5, wherein the shutting device comprises rotatable blinds or a movable screen.

7. The device according to claim 1, wherein the absorber comprises an electrochromic substance.

8. The device according to claim 1, wherein the absorber comprises an electrowetting cell.

9. The device according to claim 1, wherein the absorber comprises a liquid crystal device having at least one cell, and preferably having one cell, with an area of at least 100 cm², preferably at least 400 cm².

10. The device according to claim 1, wherein the semitransparent layer comprises a semitransparent mirror with a reflectance of between 5% and 25%, preferably between 10 and 20%.

11. The device according to claim 1, wherein the semitransparent layer comprises a fixed-image layer.

12. The device according to claim 11, wherein the fixed-image layer comprises at least one semitransparent area, in particular a continuous area extending substantially over the emission window, preferably at least partly colored.

13. The device according to claim 11, wherein the fixed-image layer comprises at least one substantially non-transparent area.

14. The device according to claim 13, wherein at least one substantially non-transparent area comprises a reflective layer facing the light source and a differently colored area facing away from the light source.

15. The device according to claim 1, wherein the light source comprises at least one fluorescent lamp.

16. The device according to claim 1, wherein the light source comprises a plurality of LEDs.

17. (canceled)

18. The device according to claim 1, wherein the illuminance at a distance of 0.5 m perpendicular to the device area is at least 1,000 lx.

19. (canceled)

20. The device according to claim 1, wherein the absorber (18) comprises at least two parts (25, 30), each of which extends over a substantial portion of the complete optical window (2), at least one of said two parts being controllable by the control unit (15) independently of another of said at least two parts (25, 30).

21. The device according to claim 20, wherein the absorber comprises a fixed absorber part having a fixed transmittance.

22. (canceled)
